(19) United States
(12) Patent Application Publication
(10) Pub. No.: US 2006/0258341 A1
(43) Pub. Date: Nov. 16, 2006

(54) Mobile internet services discovery and/or provisioning

(75) Inventors: Quentin S.C. Miller, Sammamish, WA (US); David P. Limont, Seattle, WA (US); John J. Ostlund, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/129,028

(22) Filed: May 13, 2005

(51) Int. Cl. H04Q 7/38

(52) U.S. Cl. 455/414.1

(57) ABSTRACT

Mobile internet services discovery and/or provisioning enables mobile devices to discover available internet services and/or to provision selected internet services, including any associated mobile applications. In an example implementation, a mobile internet services shell located at a mobile device presents available internet services to a user (e.g., upon powering the device on). The user is empowered to select one or more internet services for provisioning. The mobile internet services shell interacts with a mobile internet services proxy located on a network. In another example implementation, the mobile internet services proxy facilitates communications between the mobile internet services shell and other discovery or provisioning parties by translating communications between one format and another format that is proprietary to a mobile network operator. Other discovery or provisioning parties may include, for example, one or more of an internet service directory, an application server, or a provisioning server.

### TECHNICAL FIELD

This disclosure relates in general to mobile internet services and in particular, by way of example but not limitation, to facilitating the discovery and/or provisioning of mobile internet services at a mobile device.

### BACKGROUND

Internet services are services that are provided in an internet environment. Some internet service examples are email services, portal services, search services, shopping services, and so forth. Internet services have traditionally been accessed from a personal computer that is coupled to the internet.

Many internet services are also available on mobile devices in a traditional internet service version and/or in a mobile targeted internet service version. In other words, certain mobile devices that are coupled to wireless telecommunications networks are capable of providing internet services to their users. The internet services are provided at least partially through the internet and are routed through the telecommunications networks to mobile devices. Unfortunately, the number of subscriptions for and the amount of use of such internet services through mobile devices has not reached the levels desired by mobile telecommunications network operators.

### SUMMARY

Mobile internet services discovery and/or provisioning enables mobile devices to discover available internet services and/or to provision selected internet services, including any associated mobile applications. In an example implementation, a mobile internet services shell located at a mobile device presents available internet services to a user (e.g., upon turning the device on). The user is empowered to select one or more available internet services for provisioning. The mobile internet services shell interacts with a mobile internet services proxy located on a network. In another example implementation, the mobile internet services proxy facilitates communications between the mobile internet services shell and other discovery or provisioning parties by translating communications between one format and another format that is proprietary to a mobile network operator. Other discovery or provisioning parties may include, for example, one or more of an internet service directory, an application server, or a provisioning server.

Other method, system, approach, apparatus, device, media, procedure, process, API, arrangement, etc. implementations are described herein.

### BRIEF DESCRIPTION OF THE DRAWINGS

The same numbers are used throughout the drawings to reference like and/or corresponding aspects, features, and components.

FIG. 1 is a block diagram of example environments in which a mobile internet services discovery and/or provisioning framework may be implemented.

FIG. 2 is a block diagram including a mobile device having an example mobile internet services shell for discovering and provisioning mobile internet services.

FIG. 3 is a block diagram of an example mobile internet services discovery and provisioning scheme that includes a mobile internet services shell, a mobile internet services proxy, and other parties such as an internet service directory.

FIG. 4 is a block diagram of an example mobile internet services discovery and provisioning mechanism that includes a mobile internet services shell, a mobile internet services proxy, and multiple protocols.

FIG. 5 is a block diagram of an example internet service directory.

FIGS. 6A-6E form a sequence diagram that illustrates an example of a mobile internet services discovery and provisioning process.

FIG. 7 illustrates an example of a computing (or general device) operating environment that is capable of (wholly or partially) implementing at least one aspect of mobile internet services discovery and/or provisioning as described herein.

### DETAILED DESCRIPTION

### Introduction

As explained above, mobile telecommunications network operators are dissatisfied with the extent mobile device users take advantage of the mobile internet services that are offered. One reason for this insufficient market penetration may be that mobile devices usually require special configuring in order to provide or route internet services through both the internet and a telecommunications network. This special configuring is extremely complex and cumbersome. Consequently, the acceptance, acquisition, and usage of mobile internet services have been limited.

More specifically, existing mobile networks have complex methodologies (if any at all) to allow users to find internet services for their mobile devices, which limits the uptake of mobile applications. Accordingly, there is a need for schemes, mechanisms, techniques, etc. that can facilitate mobile device interfacing and interaction with mobile internet services in an efficient and/or convenient manner. In an example implementation, a centralized internet services framework that manages mobile application installation and provisioning is described. The framework is capable of linking mobile devices, mobile telecommunications network operators, and mobile internet service providers.

By way of example only, a mobile internet services shell associated with a user's mobile device discovers a mobile internet services proxy at a server in accordance with a new proxy discovery protocol. An internet services discovery protocol is used to identify services that are compatible with the user's mobile device. The client mobile internet services shell then advertises a list of available internet services to the mobile device user. The user can then select to download and provision application(s) for one or more of the available internet services using an application downloading protocol and at least one internet service provisioning protocol, respectively. Alternatively, the mobile internet services shell may automatically download and provision application(s) for one or more of the available mobile internet services without user selection at the mobile device.

Billing information may be associated with each of the available internet services. Upon selection of a mobile application/internet service, the billing information associated therewith may be incorporated into a wireless network service subscription corresponding to the user and/or into an internet service billing agreement corresponding to the user. After the mobile application(s) have been downloaded and provisioned, the user may utilize the associated internet service(s).

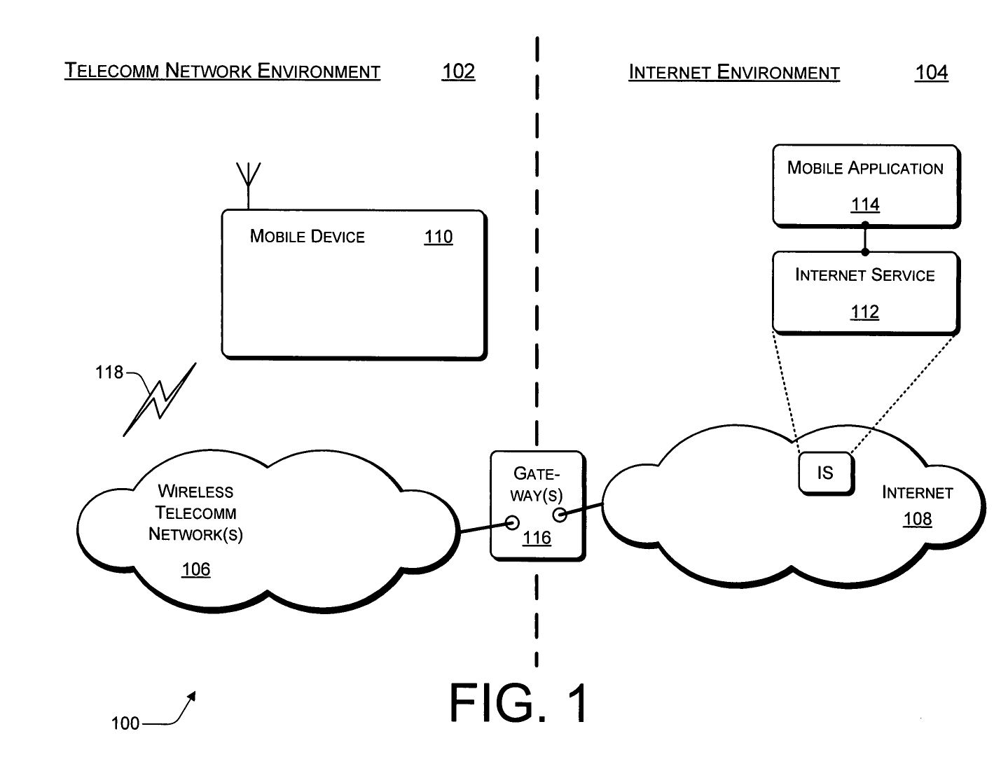

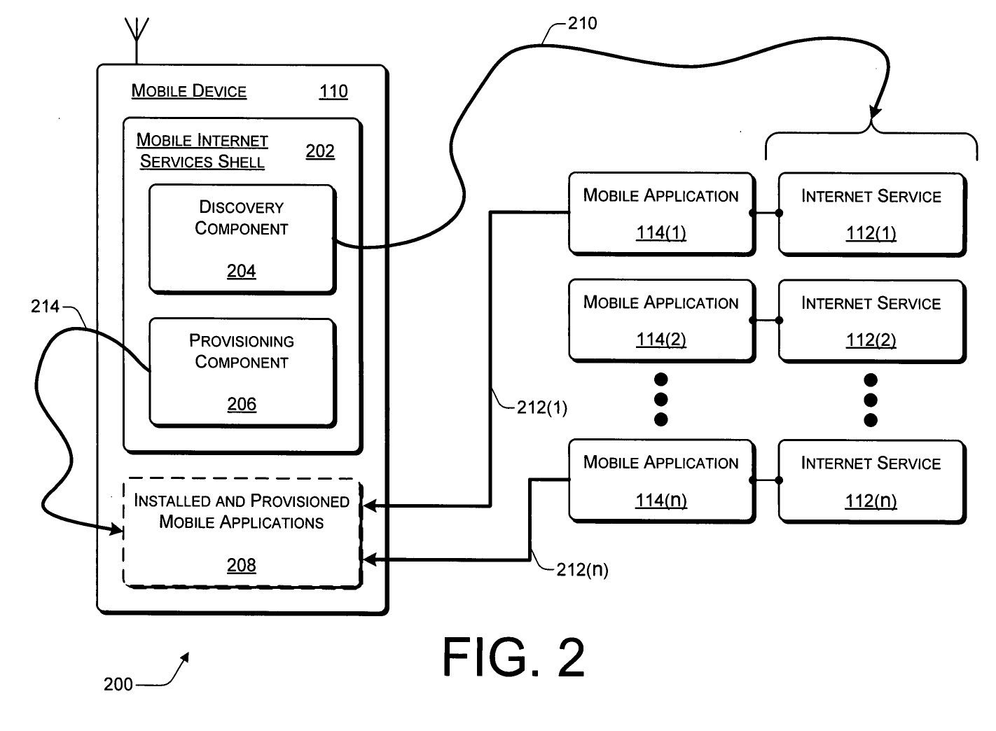

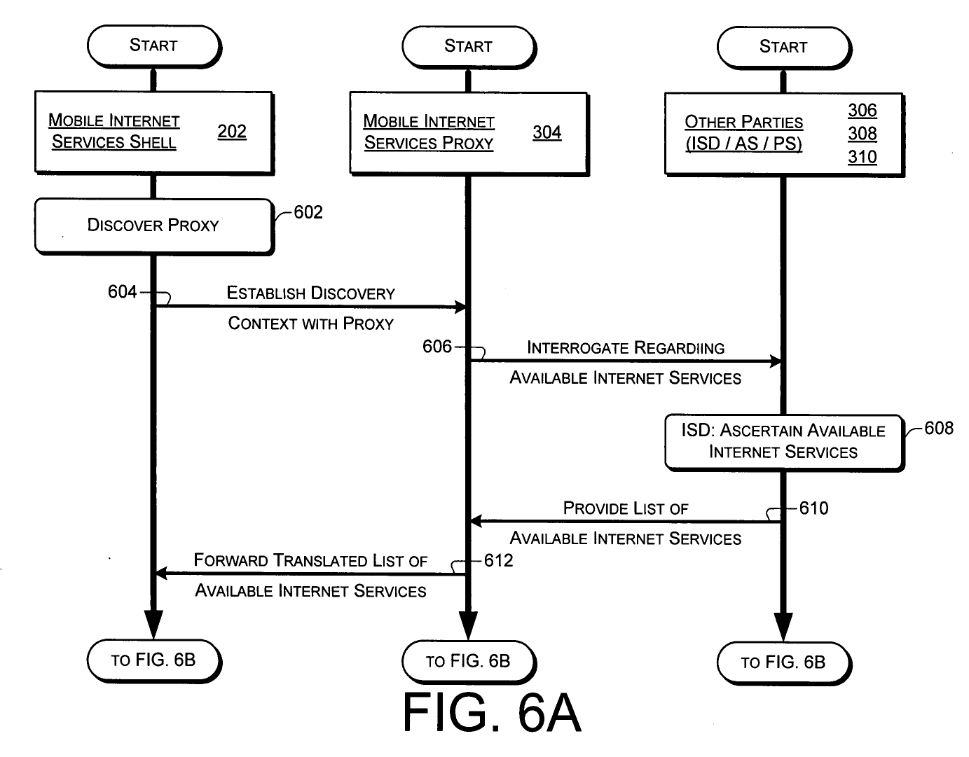

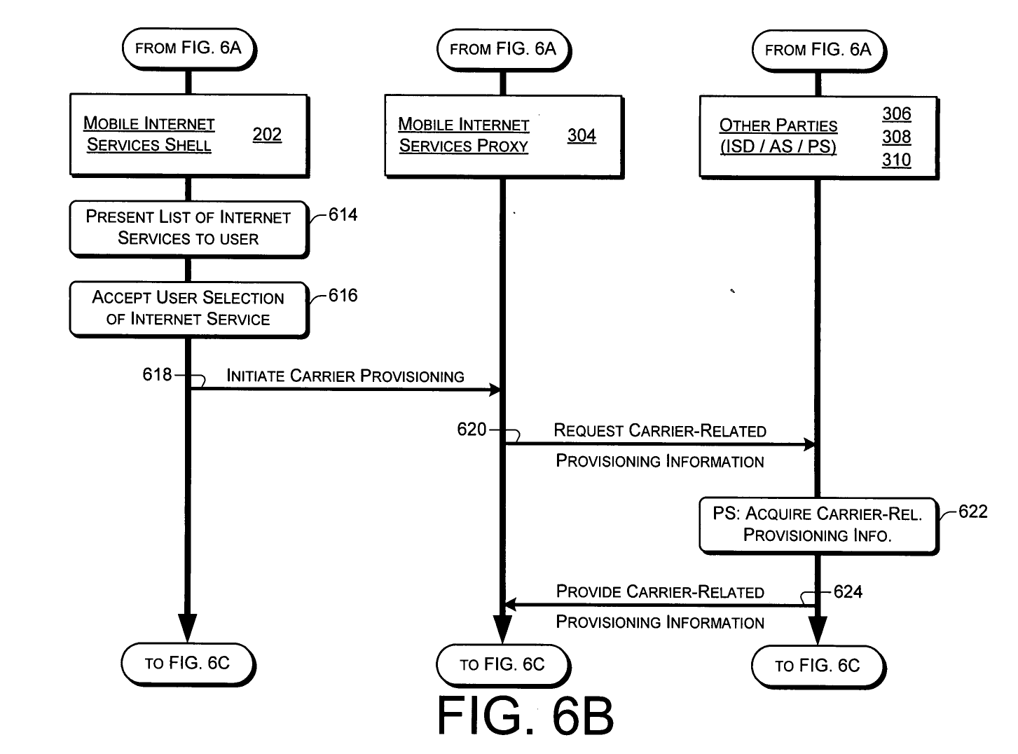

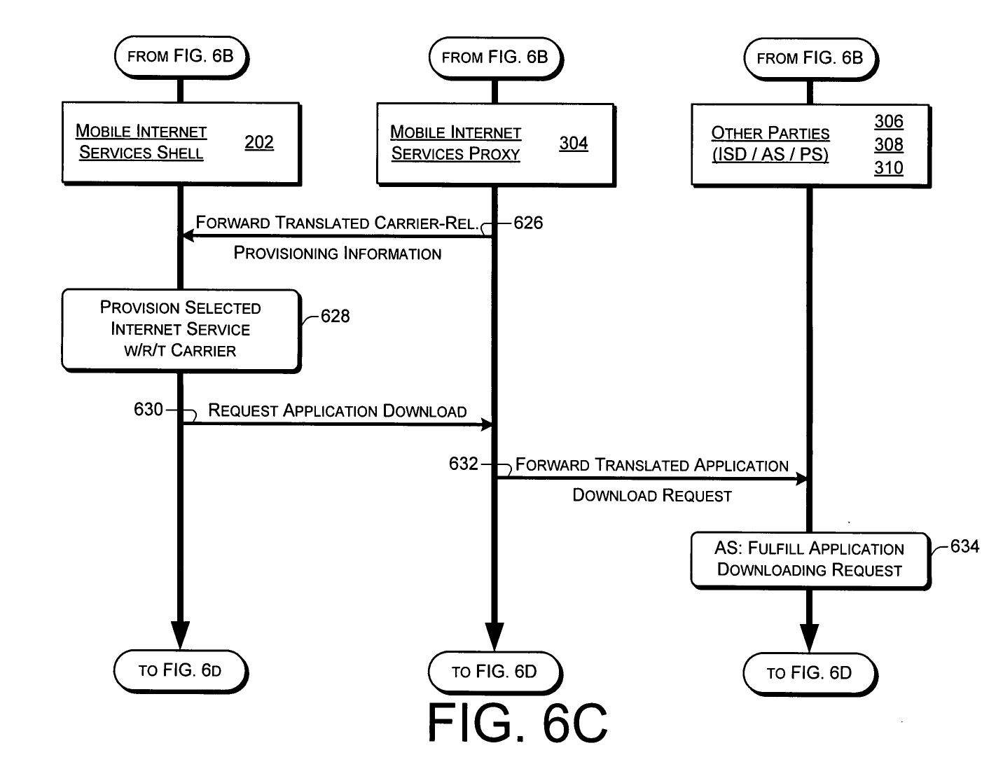

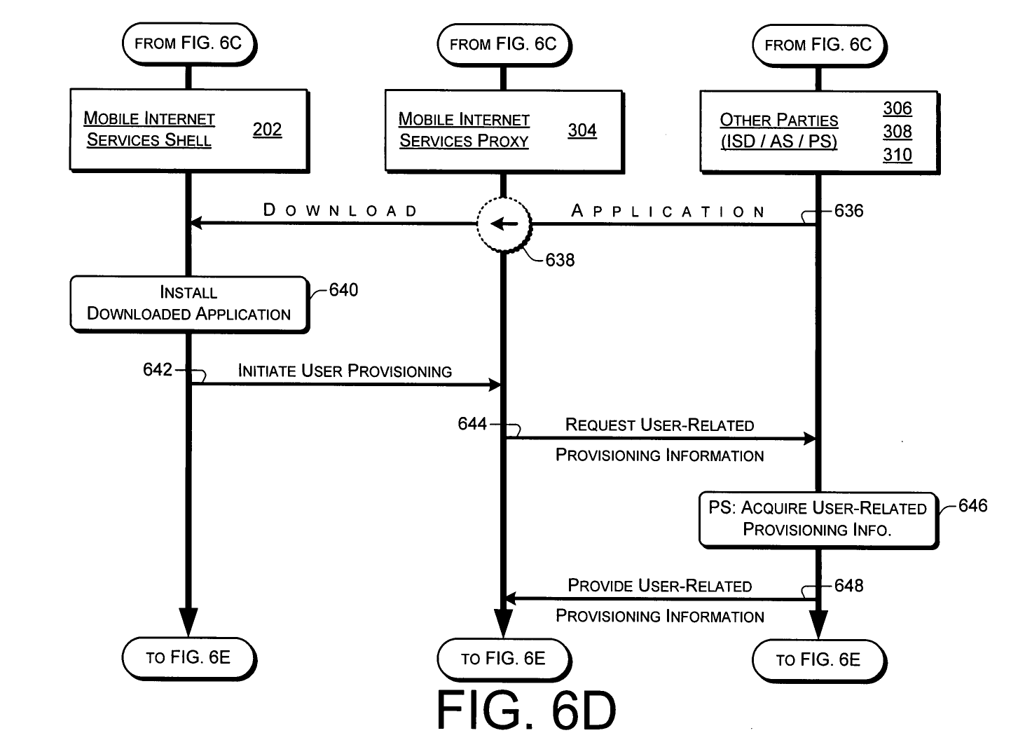

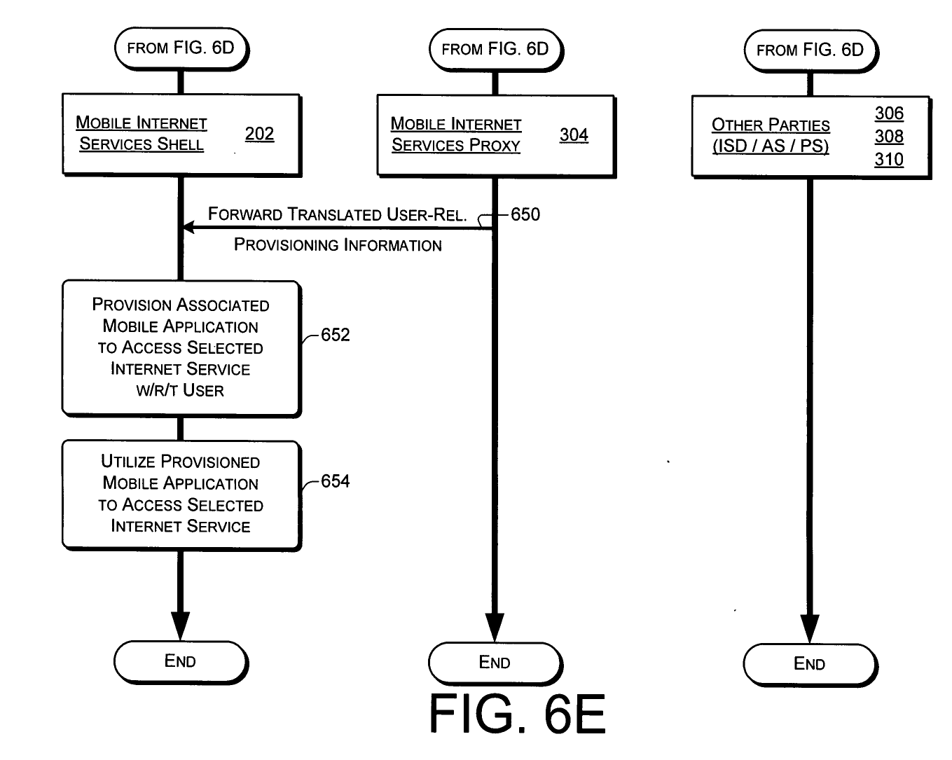

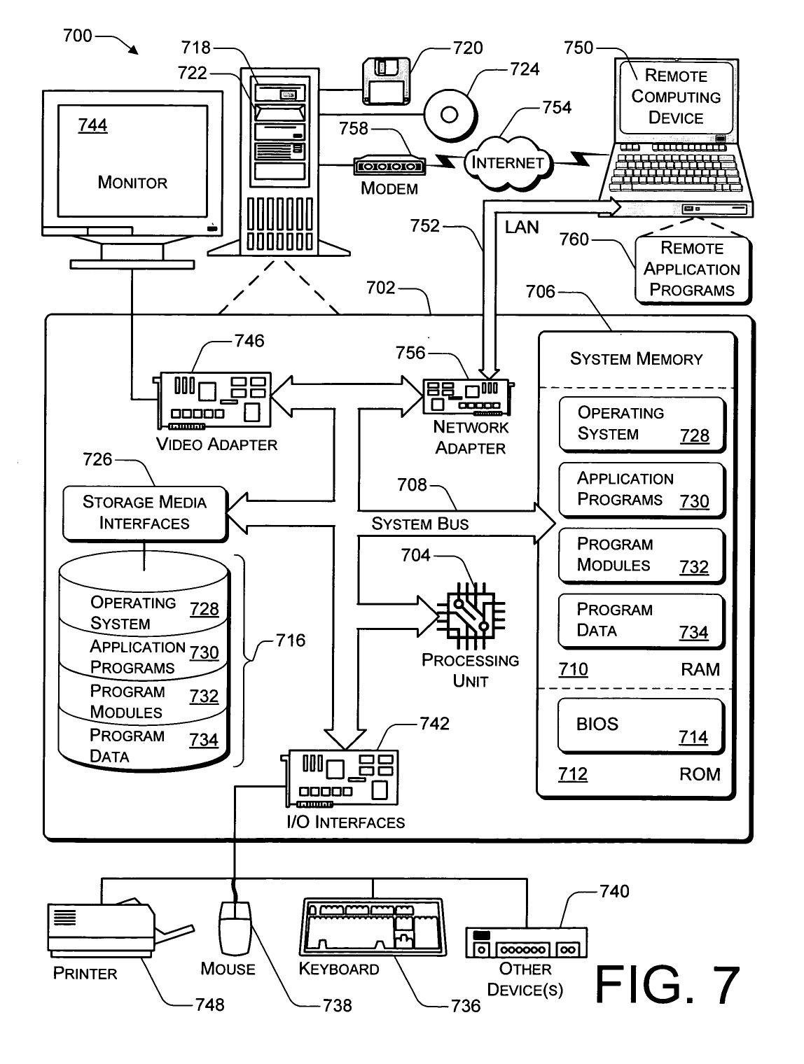

This description is separated into four sections in addition to this “Introduction” section. A first section references FIG. 1 and is entitled “Example Environments for Mobile Internet Services Discovery and/or Provisioning”. A second section references FIGS. 2-5 and is entitled “Example General Implementations for Mobile Internet Services Discovery and/or Provisioning”. A third section references FIGS. 6A-6E and is entitled “Example Process for Mobile Internet Services Discovery and/or Provisioning”. There is also a fourth section that references FIG. 7 and is entitled “Example Operating Environment for Computer or Other Device”.

### Example Environments for Mobile Internet Services Discovery and/or Provisioning

FIG. 1 is a block diagram of example environments 100 in which a mobile internet services discovery and/or provisioning framework may be implemented. Environments 100 are bifurcated into a telecommunications network environment 102 and an internet environment 104. Telecommunications network environment 102 may be comprised of one or more mobile or wireless networks, public switched telephone networks (PSTNs), some combination thereof, and so forth. Internet environment 104 may be comprised of one or more of a local area network (LAN), a wide area network (WAN), the traditional Internet, a Wi-Fi network, some combination thereof, and so forth.

As illustrated, telecommunications network environment 102 is shown to include one or more wireless telecommunications networks 106. However, it may also include one or more wired telecommunications networks. Internet environment 104 is shown to include at least one internet 108. Each of wireless telecommunications network 106 and internet 108 includes multiple network nodes. These nodes may be switches, routers, servers, gateways, exchanges, base stations, home location registers (HLRs), mobile switching centers (MSCs), some combination thereof, and so forth.

Wireless telecommunications network 106 can communicate with internet 108 via one or more gateways 116. A single gateway 116 can enable communication between wireless telecommunications network 106 and internet 108, or multiple gateways 116 may be employed. In either case, such gateway(s) 116 may be part of wireless telecommunications network 106, internet 108, both networks, or neither network from a physical, technological, network operator, and/or service provider perspective.

In a described implementation, internet environment 104 includes an internet service (IS) 112 that is coupled to (including being a part of) internet 108. In a real-world setting, multiple such internet services 112 can be and most likely are coupled to internet 108. Internet service 112 may be any general internet service, such as personal computer-based applications, embedded applications, so-called web services, some combination thereof, and so forth.

Internet service 112 is associated with mobile application 114. Hence, mobile application 114 may be used by a mobile device to access internet service 112. Such internet service accessing may encompass interfacing or interacting with, retrieving information from, providing information to, making a request of, engaging in a communication with, some combination thereof, and so forth.

Examples of internet services 112 include, but are not limited to: database accessing, scheduling information accessing, email sending/receiving, product/service ordering, web site information retrieval, game playing and online game data managing and organizing, social networking, data searching and retrieving, contact list managing, group membership managing, media metadata (e.g., music album information, movie production and cast information, etc.) managing and organizing, some combination thereof, and so forth. The related information that a mobile application is manipulating may include, but is not limited to: information from a database entry, calendar appointment information, an email and/or an attachment of an email, invoice information, weather or news information, game information, social information (e.g., social networks), search engine information (e.g., indexed data, search histories, etc.), contact information, group information, media metadata, data catalogues, some combination thereof, and so forth.

Telecommunications network environment 102 includes a mobile device 110 that is coupled to wireless telecommunications network 106 via a wireless communication link 118. In a real-world setting, multiple such mobile devices 110 can be and most likely are being supported by wireless telecommunications network 106. Mobile device 110 typically comprises a mobile telephone, a personal digital assistant (PDA), or another hand-held wireless device. Nevertheless, mobile device 110 may alternatively comprise any device having a wireless communication capability.

Mobile device 110 is capable of executing mobile application 114 to access the associated internet service 112. However, mobile device 110 cannot adequately access internet service 112 (if at all) without first provisioning mobile application 114 with respect to internet service 112. If not already present at mobile device 110, mobile device 110 loads, including downloads, mobile application 114 prior to such provisioning. Example implementations for facilitating mobile internet services discovery and/or provisioning are described in the following sections.

An access of internet service 112 by a mobile application at mobile device 110 usually entails a communication flow from mobile device 110 to wireless telecommunications network 106 via wireless link 118. The communication flow continues from wireless telecommunications network 106 to internet 108 via at least one gateway 116. Additionally, the communication flow extends to internet service 112, which is coupled to internet 108. The communication can also flow in the reverse direction from internet service 112 to mobile device 110.

### Example General Implementations for Mobile Internet Services Discovery and/or Provisioning

FIG. 2 is a block diagram 200 including a mobile device 110 having an example mobile internet services shell 202 for discovering and provisioning mobile internet services. As illustrated, mobile device 110 includes a mobile internet services shell 202 and installed and provisioned mobile applications 208.

More specifically, mobile internet services shell 202 includes a discovery component 204 and a provisioning component 206. Mobile device 110, after operation of mobile internet services shell 202, includes one or more installed and provisioned mobile applications 208. Although the example implementations that are described herein include both discovering and provisioning, a given implementation may alternatively include one or the other (e.g., discovering component 204 or provisioning component 206).

As described herein above with particular reference to FIG. 1, multiple internet services 112 are coupled to and available via internet 108. Each internet service 112 may be associated with at least one mobile application 114. As illustrated in FIG. 2, each respective internet service 112 of multiple internet services 112 is associated with at least one respective mobile application 114 of multiple mobile applications 114.

Specifically, “n” internet services 112(1 . . . n) and “n” mobile applications 114(1 . . . n) are illustrated. Internet service 112(1) is associated with mobile application 114(1). Internet service 112(2) is associated with mobile application 114(2). And internet service 112(n) is associated with mobile application 114(n). Although each internet service 112 is shown to be associated with a single mobile application 114, each internet service 112 may alternatively be associated with zero or more than one mobile application 114.

In a described implementation, mobile internet services shell 202 is activated at least when mobile device 110 is first powered on. However, it may be activated each time mobile device 110 is powered on, at regular intervals, whenever internet 108 is accessed, when the user proactively elects to activate it, upon the occurrence of some other event, some combination thereof, and so forth. An option for the user of mobile device 110 to temporarily or permanently prevent mobile internet services shell 202 from activating may be provided. Generally, mobile internet services shell 202 is adapted to discover which internet services 112 are available through mobile device 110, and mobile internet services shell 202 is capable of having selected internet services 112 provisioned for use, including any associated mobile applications 114.

Specifically, discovery component 204 is adapted to discover which internet service(s) 112 are available for mobile device 110 as is indicated by discovery arrow 210. Discovery component 204 can therefore also discover which, if any, associated mobile applications 114 are available for downloading to mobile device 110. Selected mobile applications 114 (including mobile applications 114 that are associated with selected internet services 112) are then downloaded by mobile internet services shell 202 to mobile device 110 as indicated by downloading arrows 212.

In the illustrated example, mobile application 114(1) and mobile application 114(n) are selected for downloading as indicated by downloading arrows 212(1) and 212(n), respectively. The selection may be made by the user of mobile device 110, by mobile device 110 or mobile internet services shell 202 thereof, by a mobile network operator of the user of mobile device 110 (e.g., in accordance with a contractual subscription obligation), some combination thereof, and so forth.

The downloaded mobile applications 114(1) and 114(n) are installed by mobile internet services shell 202 and/or an operating system (OS) of mobile device 110. Provisioning component 206 is adapted to provision mobile applications 114 for use with their respective internet services 112 and in conjunction with the user's mobile telecommunications network operator. In other words, provisioning component 206 is capable of configuring a mobile application 114 such that a user of mobile device 110 can access the associated internet service 112 and do so in accordance with any contractual subscription obligations. Thus, after installation, mobile applications 114(1) and 114(n) are provisioned by provisioning component 206 so that a user of mobile device 110 can access/utilize internet services 112(1) and 112(n), respectively, using installed and provisioned mobile applications 208.

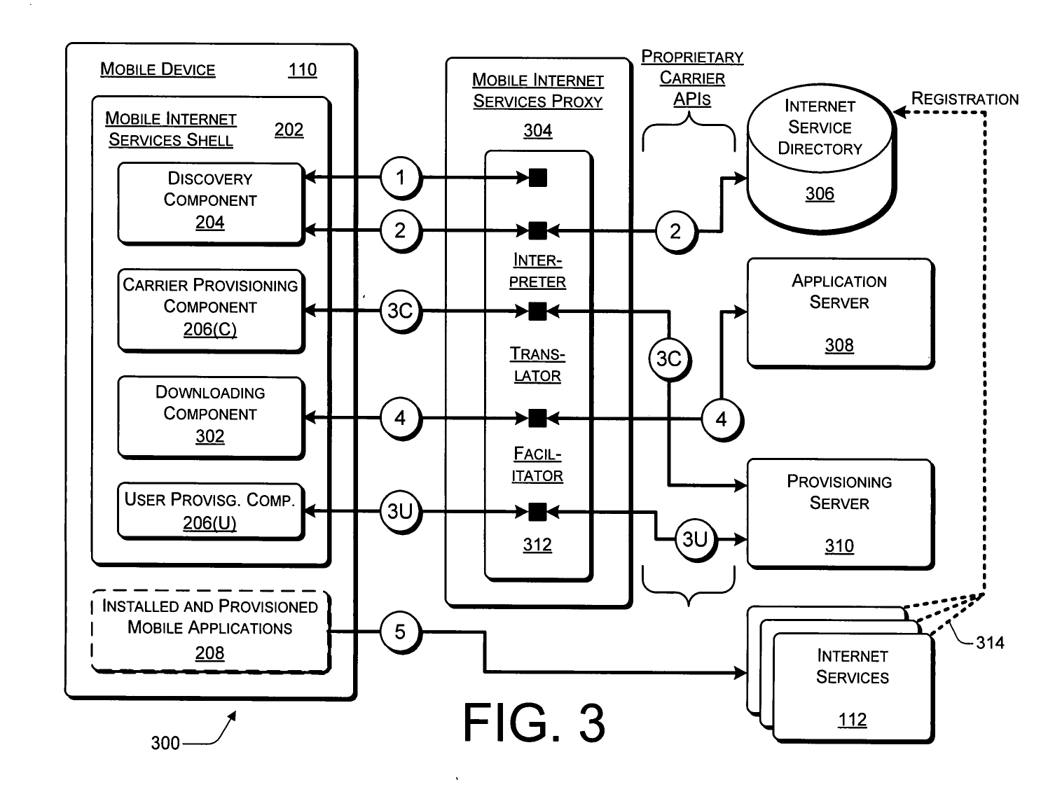

FIG. 3 is a block diagram of an example mobile internet services discovery and/or provisioning scheme 300 that includes a mobile internet services shell 202, a mobile internet services proxy 304, and multiple other parties such as an internet service directory 306. As illustrated, scheme 300 includes mobile device 110 having mobile internet services shell 202. Mobile internet services shell 202 includes discovery component 204, provisioning components 206(C) and 206(U), and a downloading component 302. Provisioning component 206 (of FIG. 2) is divided into a carrier provisioning component 206(C) and a user provisioning component 206(U). At least after operation of scheme 300, mobile device 110 also includes installed and provisioned mobile applications 208.

In a described implementation, mobile internet services proxy 304 is effectively an active conduit to a number of internet-service-related entities. The internet-service-related entities comprise other parties to certain implementations of mobile internet services discovery and/or provisioning as described herein. These internet-service-related entities include: an internet service directory 306, an application server 308, a provisioning server 310, and one or more internet services 112. Mobile internet services proxy 304 may be realized at any node of telecommunications network environment 102 (of FIG. 1) and/or internet environment 104 (including gateway 116). Moreover, mobile internet services proxy 304 may be distributed across multiple nodes.

The physical infrastructure of at least internet service directory 306, application server 308, and provisioning server 310 may be located within telecommunications network environment 102 and/or internet environment 104. Also, although each of the internet-service-related entities is shown as a separate block in FIG. 3, one or more of them may be co-located at the same node and/or may be operating with the same device hardware.

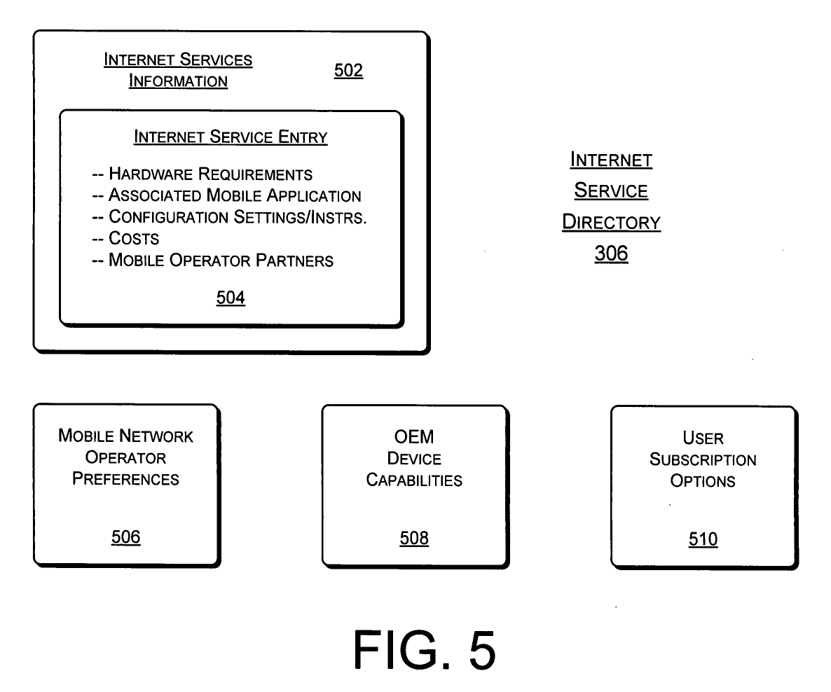

Internet service directory 306 includes multiple entries directed to internet services 112. Each entry includes information describing the corresponding internet service 112. Such information may include capabilities, cost structure, compatibility data, and general configuration data for provisioning purposes. Optionally, internet service directory 306 may be part of mobile internet services proxy 304. An example implementation of internet service directory 306 is described further herein below with particular reference to FIG. 5.

Application server 308 stores respective mobile applications 114 (of FIGS. 1 and 2) that are associated with respective internet services 112. Application server 308 is capable of downloading the mobile applications 114 that are stored thereat to mobile devices 110.

Provisioning server 310 is capable of provisioning mobile applications 114 that are downloaded and installed or that are to be downloaded or installed at mobile device 110. Provisioning information is accessible to provisioning server 310. The provisioning information may be located at provisioning server 310, internet service directory 306, or some other location. Provisioning server 310 is adapted to cooperate with provisioning components 206(C) and 206(U) of mobile internet services shell 202 during the provisioning process. The provisioning information is used by provisioning server 310 and provisioning components 206 to prepare for downloading of mobile applications 114 and/or to properly provision installed mobile applications 114 to produce installed and provisioned mobile applications 208.

Internet services 112 that wish to participate in the discovery and provisioning scheme 300 register with internet service directory 306. This registration is indicated by registration arrow 314. To register, a given internet service 112 inserts into internet service directory 306 an internet service directory entry that corresponds to the given internet service 112. As explained above, the internet service directory entry can include information describing the corresponding internet service 112. Each internet service 112 may auto register with internet service directory 306, or internet service directory 306 may be maintained manually. Alternatively, internet service directory 306 may be built and/or maintained using a combination of both approaches.

Mobile internet services proxy 304 is capable of facilitating the discovery and provisioning of internet services 112 on behalf of a mobile device 110 and a user thereof. Mobile internet services proxy 304 is capable of providing a uniform interface to mobile internet services shells 202 of mobile devices 110. Generally, there are different proprietary carrier application programming interfaces (APIs) or carrier protocols for different mobile network operators. These APIs or protocols may also be frequently changed by the carriers.

It is challenging to attempt to enable every mobile device 110 from every original equipment manufacturer (OEM) to communicate with every possible proprietary carrier API. Mobile internet services proxy 304 therefore performs an interpretation and translation function in order to facilitate communications between mobile internet services shells 202 of mobile devices 110 and various mobile network operator entities. These functions are represented by interpreter-translator-facilitator (ITF) component 312.

ITF component 312 is adapted to interpret incoming discovery and/or provisioning communications and translate them into the appropriate proprietary carrier APIs for the mobile network operator of the user of mobile device 110. Similarly, ITF component 312 is adapted to interpret incoming communications in a proprietary carrier API into another format that is compatible for mobile internet services shell 202.

An example operation of scheme 300 is described in five phases as is indicated by the encircled numerals (1), (2), (3), (4), and (5). At phase (1), discovery component 204 of mobile internet services shell 202 discovers mobile internet services proxy 304. The discovery can be effectuated using any of many currently available protocols (e.g., Serial Interface Protocol (SIP), Universal Plug and Play (UPnP), etc.) or a specially-developed protocol. A mechanism for accessing mobile internet services proxy 304 may be hardwired into mobile device 110 or the location of mobile internet services proxy 304 may be discoverable in accordance with some discovery protocol.

At phase (2), discovery component 204, in conjunction with mobile internet services proxy 304, discovers available internet services 112. ITF component 312 translates a communication requesting a listing of available internet services 112. ITF also queries internet service directory 306 in order to retrieve a number (zero or more) of internet services 112 that are appropriate for mobile device 110. Appropriateness may be based on hardware capabilities, software compatibilities, mobile network operator preferences, user subscription parameters, and so forth. Those internet services 112 that are retrieved from internet service directory 306 are then identified by mobile internet services proxy 304 to discovery component 204.

Although other factors may be considered, in a described implementation, the identified internet services 112 include those that have associated mobile applications 114 that are compatible with mobile device 110 and exclude those that are associated with incompatible mobile applications 114. The identified internet services 112 may also be limited to those that are available to a user of mobile device 110 based on the user's subscription with the mobile network operator. For each identified internet service 112, corresponding retail prices, terms of use (TOU), and a universal resource indicator (URI) for application installation may be included as part of the discovery phase for identified internet services 112.

During phase (2), the identified mobile applications 114 and/or internet services 112 are presented by mobile internet services shell 202 to a user of mobile device 110. The user may be provided an opportunity to select none, one, or more of the available internet services 112 and mobile applications 114. The remaining phases are described given that one internet service 112 and its associated mobile application 114 are selected by the user.

Phase (3) is divided into a carrier provisioning phase (3C) and a user provisioning phase (3U), with a downloading phase (4) occurring between them. At phase (3C), carrier provisioning component 206(C) of mobile internet services shell 202 and provisioning server 310 coordinate, via mobile internet services proxy 304, to provision for the selected mobile application 114. For example, provisioning server 310 can provide carrier-level provisioning information, including provisioning instructions, to carrier provisioning component 206(C).

After receiving the carrier-level provisioning information from provisioning server 310, carrier provisioning component 206(C) is capable of performing carrier-related provisioning for the selected internet service 112 and associated mobile application 114. The carrier-related provisioning may entail, for example, one or more of the following service managing parameters: mobile operator and/or network, user-affiliated corporation, software versions, regions/locales, and so forth.

At phase (4), downloading component 302 of mobile internet services shell 202 cooperates with application server 308 to download mobile applications 114 that are associated with selected ones of the identified internet services 112. The actual downloading may be accomplished with a wireless or a wired connection, depending on mobile application size, relative connection speeds, and carrier or user preference. The downloading operations between downloading component 302 and application server 308 may be facilitated by ITF component 312 of mobile internet services proxy 304, or the operations may be effectuated without an intermediary.

After downloading, installation of downloaded mobile applications 114 may be managed by an operating system (OS) of mobile device 110, by mobile internet services shell 202, by a dedicated installation wizard, some combination thereof, and so forth. Examples of OSes that may execute on mobile device 110 include, but are not limited to, Java 2 Micro Edition (J2ME), Binary Run-time Environment for Wireless (BREW), Symbian OS, Windows® Mobile OS, Palm OS, and so forth.

At phase (3U), user provisioning component 206(U) of mobile internet services shell 202 and provisioning server 310 coordinate, via mobile internet services proxy 304, to provision the selected mobile application 114. For example, provisioning server 310 can provide user-level provisioning information, including provisioning instructions, to user provisioning component 206(U).

After receiving the user-level provisioning information from provisioning server 310, user provisioning component 206(U) is capable of performing user-related provisioning for the selected internet service 112 and associated mobile application 114. The user-related provisioning may entail, for example, one or more of the following service managing parameters: activating established user preferences, enforcing obligations of the user's mobile service subscription contract, accommodating device capabilities that are relevant to provisioning a mobile application 114 for a specific mobile device 110, and so forth.

At phase (5), a user may access the selected internet service 112 with the associated installed and provisioned mobile applications 208. After installing and provisioning the selected mobile application 114 to create a new installed and provisioned mobile application 208, the associated internet service 112 may be utilized by a user of mobile device 110 without further assistance from mobile internet services proxy 304.

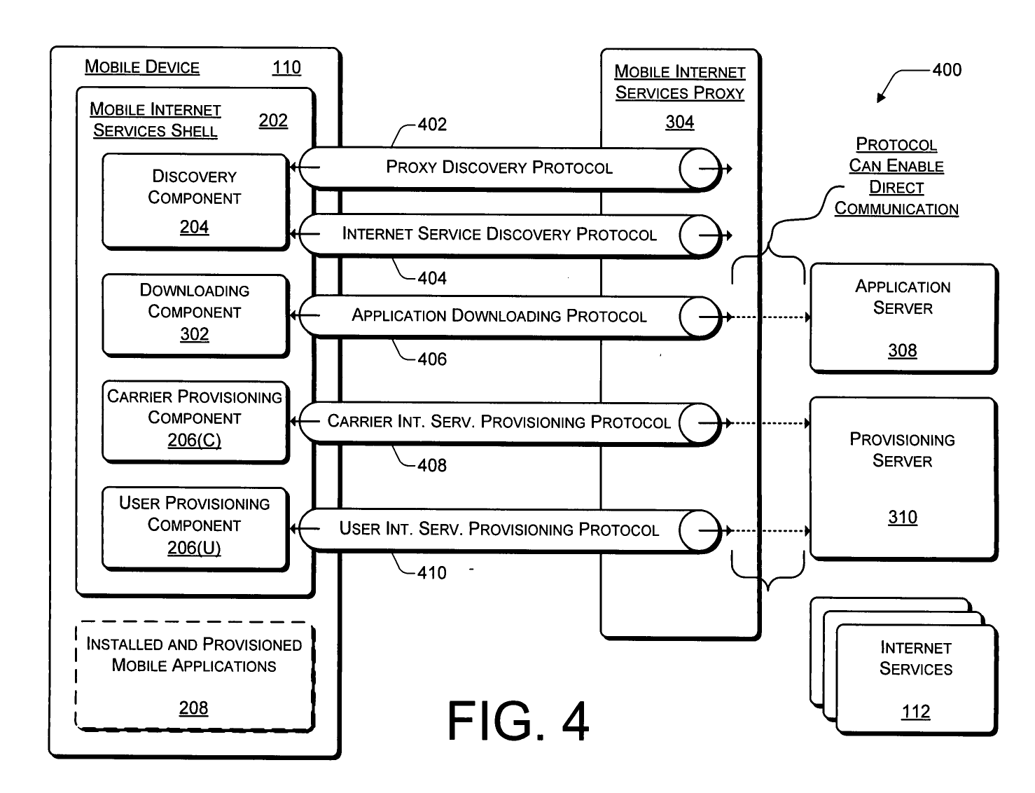

FIG. 4 is a block diagram of an example mobile internet services discovery and/or provisioning mechanism 400 that includes a mobile internet services shell 202, a mobile internet services proxy 304, and multiple protocols 402-410. As illustrated, these protocols include a proxy discovery protocol 402, an internet service discovery protocol 404, an application downloading protocol 406, a carrier internet service provisioning protocol 408, and a user internet service provisioning protocol 410.

In a described implementation, proxy discovery protocol 402 and internet service discovery protocol 404 enable communications between mobile internet services shell 202 and mobile internet services proxy 304. The other illustrated protocols can enable communications between mobile internet services shell 202 and mobile internet services proxy 304 or individual provisioning entities. Specifically, application downloading protocol 406 can enable communications between mobile internet services shell 202 and mobile internet services proxy 304 or directly between mobile internet services shell 202 and application server 308. Similarly, carrier internet service provisioning protocol 408 and user internet service provisioning protocol 410 can enable direct communications between mobile internet services shell 202 and provisioning server 310, as well as between mobile internet services shell 202 and mobile internet services proxy 304.

As described above, mobile internet services shell 202 discovers a mobile internet services proxy 304 and establishes a security context with the proxy. The discovery and context establishment is enabled by proxy discovery protocol 402. The discovery may be effectuated by discovery component 204 through any of many possible manners. For example, there can be a broadcast message within wireless telecommunications network 106 that mobile internet services shell 202 of mobile device 110 detects in accordance with proxy discovery protocol 402. Alternatively, mobile internet services shell 202 of mobile device 110 may ask wireless telecommunications network 106 for the accessing instructions to (e.g., the URI of) mobile internet services proxy 304 in accordance with proxy discovery protocol 402.

Once a security context is established with the discovered mobile internet services proxy 304, mobile internet services shell 202 can discover through mobile internet services proxy 304 those internet services 112 that are available to a user of mobile device 110. In accordance with internet service discovery protocol 404, discovery component 204 may provide mobile internet services proxy 304 with characteristics that are relevant to internet services generally. These characteristics may include, for example, an OEM designation for mobile device 110, a customer identification for the user of mobile device 110, a name of the associated mobile network operator, a type of mobile network of wireless telecommunications network 106, and so forth.

In response, mobile internet services proxy 304 interrogates internet service directory 306 (of FIGS. 3 and 5) to ascertain which internet services 112 are available to the user of mobile device 110. An example of such interrogation and ascertainment is described further herein below with particular reference to FIG. 5. A listing of the available internet services 112 are then provided from mobile internet services proxy 304 to mobile internet services shell 202 in accordance with internet service discovery protocol 404.

The user is presented with the available internet services 112 by mobile internet services shell 202. The user can then select one or more of the presented internet services 112. Selected internet services 112 may be downloaded in accordance with application downloading protocol 406. The available internet services listing that is provided to discovery component 204 with internet service discovery protocol 404 may include URIs for each mobile application 114 that is associated with each identified internet service 112. Otherwise, a protocol (e.g., protocol 404 or 406) may enable downloading component 302 to otherwise ascertain URIs for the selected one or more mobile applications 114.

The carrier-level provisioning is effectuated in accordance with carrier internet service provisioning protocol 408. The user-level provisioning is effectuated in accordance with user internet service provisioning protocol 410. Examples of communications between and among carrier provisioning component 206(C), user provisioning component 206(U), mobile internet services proxy 304, and provisioning server 310 in accordance with carrier internet service provisioning protocol 408 and user internet service provisioning protocol 410 are described below with particular reference to FIG. 6.

FIG. 5 is a block diagram of an example internet service directory 306. As illustrated, internet service directory 306 includes internet services information 502, mobile network operator preferences 506, OEM device capabilities 508, and user subscription options 510. Internet services information 502 includes multiple internet service entries 504. With reference to FIG. 3, each respective internet service entry 504 may be created, updated, and/or maintained within internet service directory 306 by a respective internet service 112 as indicated by registration arrow 314.

In a described implementation, each internet service entry 504 includes information related to the associated internet service 112. By way of example only, such information may include an identification of the associated mobile application 114, hardware requirements for the associated mobile application 114, configuration settings and/or instructions for the associated mobile application 114 and/or a mobile device 110 that is to run the mobile application, costs for internet service 112, mobile network operator partners that permit or favor the associated internet service 112, and so forth.

The identification of the associated mobile application 114 may include a name, a version number, a URI for downloading mobile application 114, and so forth. Internet service entry 504 may also specify which version of mobile application 114 is preferred or compatible with each named mobile network operator partner.

Generally, the configuration instructions are an enumeration of configuration steps to be taken by mobile internet services shell 202 and/or mobile internet services proxy 304 in order to configure the associated mobile application 114. The configuration instructions can be divided into carrier configuration instructions and user configuration instructions to correspond respectively to carrier internet service provisioning protocol 408 and user internet service provisioning protocol 410. Configuration settings indicate those settings of the associated mobile application 114 that enable it to work with the internet service 112.

Mobile network operator preferences 506 are preferences (including optional and mandatory preferences) established by the multiple mobile network operators. These operator/carrier preferences may include, for example, network settings, protocol settings, device settings, application-specific settings, etc., such as General Packet Radio Service (GPRS) connection settings, Wireless Application Protocol (WAP) browser settings, Wireless Village (WV) client settings, and so forth.

OEM device capabilities 508 include the capabilities of multiple OEM devices, such as mobile devices 110. These capabilities may include, for example, technical specifications, general compatibilities, general or specific communication settings, and so forth.

User subscription options 510 include subscription information for users/subscribers of the mobile network operators. For example, a given entry in user subscription options 510 may identify the mobile network operator of the user, a subscription plan, specific allowed internet services 112 or general allowed internet service types, directions for establishing billing procedures, and so forth.

In addition to internet services 112, other parties that are directly or indirectly related to providing or enabling internet services 112 on mobile devices 110 may provide information for internet service directory 306. For example, mobile network operators may supply the information for mobile network operator preferences 506 and user subscription options 510. The information of OEM device capabilities 508 may be supplied by OEMs and/or mobile network operators.

The information contained by internet service directory 306 may be organized differently from how it is illustrated in FIG. 5 and described above. For example, the information of OEM device capabilities 508 may be included in individual internet service entries 504 and tailored for the associated mobile application 114. Similarly, the preference information of mobile network operator preferences 506 may be distributed into individual internet service entries 504 and/or individual user subscription entries of user subscription options 510.

Furthermore, the information may be located at other entities, such as application server 308, provisioning server 310, some mobile network operator-controlled site, and so forth. For example, the configuration settings/instructions of internet service entries 504 may be located at provisioning server 310, and OEM device capabilities 508 may be located at application server 308.

The following describes an example usage in the context of a new mobile phone purchase. Thus, mobile device 110 in this example comprises a mobile phone. Initially, a user purchases a new mobile phone with mobile internet services support from a mobile network operator. The user unpacks the new mobile phone and powers it on.

Although mobile internet services shell 202 may be activated manually, the mobile phone automatically activates mobile internet services shell 202 in this example, at least upon being first powered on. Discovery component 204 of mobile internet services shell 202 discovers the presence of a mobile internet services proxy 304 in the user's mobile operator's network [corresponding to phase (1) of FIG. 3].

Discovery component 204 also discovers, via mobile internet services proxy 304, a list of (e.g., mobile) internet services 112 that are available to the user [phase (2)]. The mobile network operator of the user may choose to limit the internet services 112 that are available to the user based on the user's subscription. For instance, a consumer subscription package might be limited to consumer-orientated internet services 112, and an enterprise-level subscription package might be limited to enterprise services provided by the user's employer.

In this example, the user is provided a list of 20+ consumer-oriented internet services 112 that are individually identified. This listing includes a package of email/portal/search services (e.g., as provided by MSN® from Microsoft® Corporation), a ticket purchasing service, and a shopping service. The list includes pricing and terms of use (TOU) details for each available internet service. Because of the user's mobile life style, the user selects the email/portal/search service package, the ticket purchasing service, and the shopping service. The user's subscription with the mobile network operator includes one free service. Hence, the user elects the email/portal/search service package to be the free service, and the user agrees to accept billing for both the ticket purchasing service and the shopping service.

At this point, mobile internet services shell 202 downloads the selected mobile applications 114 (e.g., the application clients) that are associated with these three internet services 112. The email/portal/search mobile application 114 is downloaded directly from a shop run by the mobile operator, but the other two mobile applications 114 are downloaded from their respective internet services 112 [phase (4)]. The three mobile applications 114 are automatically instantiated in mobile internet services shell 202 after downloading.

The user accesses the email/portal/search mobile application 114 client, which prompts the user for some personal information. The client then proceeds to provision the user's email account for mobile access [phase (3U)]. For example, the mobile application 114 client may use the configuration provisioning information that is loaded by provisioning component 206. In other words, there are at least two possible paths (that are not mutually exclusive) for provisioning a mobile application 114. First, a mobile application 114 may be provisioned through a carrier provisioning path. This would usually occur shortly after downloading and installing an application. Second, a mobile application 114 may be provisioned directly with the application service. This would usually occur upon initial launch of an application.

The user then synchronizes the email and starts an instant message session with a friend to tell the friend about the convenient and easy-to-use new phone that was just turned on and is already connected to the internet. In other words, internet usage with a new mobile phone is facilitated by the provisioning of desired internet services 112 responsive to the interaction between mobile internet services shell 202 and mobile internet services proxy 304.

### Example Process for Mobile Internet Services Discovery and/or Provisioning

FIGS. 6A-6E form a sequence diagram that illustrates an example of a mobile internet services discovery and/or provisioning process. The sequence diagram starts at FIG. 6A, extends across FIGS. 6B-6D, and ends at FIG. 6E. Although the actions of this sequence diagram may be performed in other environments and with a variety of hardware and software combinations, FIGS. 1-5 are used in particular to illustrate certain aspects and examples of the process.

Thus, by way of example only, there are three major participants or categories of the mobile internet services discovery and provisioning process. These three major participants or categories are: mobile internet services shell 202, mobile internet services proxy 304, and other parties (ISD/AS/PS) 306/308/310. These other parties are: internet service directory (ISD) 306, application server (AS) 308, and provisioning server (PS) 310.

At action 602, a proxy is discovered by a discovery component 204 of mobile internet services shell 202 (e.g., in accordance with proxy discovery protocol 402) as described herein above.

At action 604, a discovery context is established with mobile internet services proxy 304. The discovery session context may be secured. As part of the discovery context, mobile internet services shell 202 provides discovery information to mobile internet services proxy 304. This discovery information may include, for example, a user identifier, an OEM device model and/or serial number, a mobile network operator corresponding to the user, an OS of the mobile device, and so forth (e.g., in accordance with internet service discovery protocol 404).

At action 606, ITF component 312 of mobile internet services proxy 304 repackages the discovery information to comport with a carrier protocol and performs an interrogation regarding available internet services on behalf of mobile internet services shell 202. Specifically, mobile internet services proxy 304 interrogates internet service directory 306.

At action 608, an internet service directory ascertains the available internet services. For example, internet service directory 306 may analyze any of internet services information 502, mobile network operator preferences 506, OEM device capabilities 508, user subscription options 510, etc. in accordance with an established procedure. Procedures may vary by the mobile network operator, by the mobile device, by subscription levels, some combination thereof, and so forth.

For example, a particular mobile network operator may restrict different internet services 112 to different subscription levels. Also, less sophisticated mobile devices 110 may be excluded from accessing internet services 112 with complicated interfaces (e.g., with demanding mobile applications 114). Regardless of exactly how they are ascertained, a list of available internet services is assembled. For each internet service that is ascertained to be available, an associated internet service entry 504 (if relevant) is included as part of the available listing. Any or all of the information forming each internet service entry 504 may be included in the list.

At action 610, the list of available internet services is provided from internet service directory 306 to mobile internet services proxy 304. Mobile internet services proxy 304 accepts the listing in a carrier protocol format and repackages or translates the listing into another format (e.g., in accordance with internet service discovery protocol 404).

At action 612, the translated list of available internet services is forwarded from mobile internet services proxy 304 to mobile internet services shell 202 (e.g., in accordance with internet service discovery protocol 404).

Continuing the sequence diagram with FIG. 6B, at action 614, mobile internet services shell 202 presents or advertises the list of available internet services to the user of the mobile device. The presentation may be accomplished with text and/or graphics and in a menu-based and/or web-page-style layout.

At action 616, mobile internet services shell 202 accepts one or more internet service selections from the user. In this example process, one internet service is selected.

At action 618, carrier provisioning component 206(C) of mobile internet services shell 202 initiates carrier provisioning for the selected internet service (e.g., in accordance with carrier internet service provisioning protocol 408). Although the provisioning protocols may empower mobile internet services shell 202 to interact directly with a provisioning server 310, this example process assumes that mobile internet services proxy 304 is used as an intermediary that performs translation between mobile internet services proxy-shell protocols and carrier protocols.

At action 620, mobile internet services proxy 304 requests carrier-related provisioning information from provisioning server 310 using a carrier-appropriate protocol or API.

At action 622, provisioning server 310 acquires the carrier-related provisioning information. The carrier-related provisioning information may be co-located with provisioning server 310 or located at internet service directory 306. The carrier-related provisioning information may include, for example, any one or more of the following: network settings, protocol settings, device settings, application-specific settings, etc., such as General Packet Radio Service (GPRS) connection settings, Wireless Application Protocol (WAP) browser settings, Wireless Village (WV) client settings, and so forth. At action 624, the carrier-related provisioning information is provided from provisioning server 310 to mobile internet services proxy 304.

Continuing the sequence diagram with FIG. 6C, after translation from a carrier protocol to a proxy-shell protocol, at action 626 the translated carrier-related provisioning information is forwarded from mobile internet services proxy 304 to mobile internet services shell 202.

At action 628, the selected internet service is provisioned with the carrier-related provisioning information by carrier provisioning component 206(C) with respect to the user's wireless carrier.

At action 630, downloading component 302 of mobile internet services shell 202 requests that the mobile application 114 associated with the selected internet service 112 be downloaded (e.g., in accordance with application downloading protocol 406). Identification of the associated mobile application 114 may be given to mobile internet services shell 202 with the listing of available internet services and/or as part of the carrier-related provisioning information. Alternatively, knowledge of the full identification (e.g., the downloading location) may be restricted to mobile internet services proxy 304.

At action 632, a protocol-translated mobile-application-downloading request is forwarded from mobile internet services proxy 304 to application server 308. At action 634, application server 308 commences to fulfill the mobile application downloading request.

Continuing the sequence diagram with FIG. 6D, at action 636 the requested mobile application, which is associated with the selected internet service, is downloaded to downloading component 302 of mobile internet services shell 202 from application server 308. As indicated by arrow 638, the mobile application download may be routed through and/or facilitated by mobile internet services proxy 304. At action 640, the downloaded application is installed by mobile internet services shell 202, possibly in conjunction with an OS of the mobile device.

Although provisioning has been generally described herein as entailing a carrier provisioning phase and a user provisioning phase, the provisioning may be completed in an alternative manner. For example, provisioning may be accomplished in a single phase or over three or more phases.

At action 642, user provisioning component 206(U) of mobile internet services shell 202 initiates user provisioning for the selected internet service and associated mobile application (e.g., in accordance with user internet service provisioning protocol 410). At action 644, mobile internet services proxy 304 requests user-related provisioning information from provisioning server 310 using a carrier-appropriate protocol or API.

At action 646, provisioning server 310 acquires the user-related provisioning information. The user-related provisioning information may be co-located with provisioning server 310 or located at internet service directory 306. The user-related provisioning information may include, for example, any one or more of the following: authentication information (e.g., user name, domain name, etc.); application-specific information (e.g., email server URI, instant message server URI, junk email rules, etc.); application-specific settings (e.g., user interface (UI) preferences, network performance settings (packet size, access rate, etc.), application look and feel (layout, color, etc.), or other application configurable parameters); and so forth. At action 648, the user-related provisioning information is provided from provisioning server 310 to mobile internet services proxy 304.

Continuing the sequence diagram with FIG. 6E, after translation from a carrier protocol to a proxy-shell protocol by ITF component 312, at action 650 the translated user-related provisioning information is forwarded from mobile internet services proxy 304 to mobile internet services shell 202.

At action 652, the associated mobile application is provisioned to access the selected internet service by user provisioning component 206(U) with the user-related provisioning information and with respect to the user and the user's mobile device. At action 654, the provisioned mobile application is utilized to access the selected internet service.

The devices, actions, aspects, features, functions, procedures, modules, data structures, components, etc. of FIGS. 1-6E are illustrated in diagrams that are divided into multiple blocks. However, the order, interconnections, interrelationships, layout, etc. in which FIGS. 1-6E are described and/or shown are not intended to be construed as a limitation, and any number of the blocks can be modified, combined, rearranged, augmented, omitted, etc. in any manner to implement one or more systems, methods, devices, procedures, processes, media, apparatuses, APIs, arrangements, etc. for mobile internet services discovery and/or provisioning. Furthermore, although the description herein includes references to specific implementations (including a general device of FIG. 7), the illustrated and/or described implementations can be implemented in any suitable hardware, software, firmware, or combination thereof and using any suitable communication protocol(s), appropriate configuration parameter(s), internet services information organization(s), and/or installation and provisioning order(s), and so forth.

### Example Operating Environment for Computer or Other Device

FIG. 7 illustrates an example computing (or general device) operating environment 700 that is capable of (fully or partially) implementing at least one system, device, apparatus, component, arrangement, protocol, approach, method, procedure, media, application programming interface (API), some combination thereof, etc. for mobile internet services discovery and/or provisioning as described herein. Operating environment 700 may be utilized in the computer and network architectures described below.

Example operating environment 700 is only one example of an environment and is not intended to suggest any limitation as to the scope of use or functionality of the applicable device (including computer, network node, entertainment device, mobile appliance, general electronic device, etc.) architectures. Neither should operating environment 700 (or the devices thereof) be interpreted as having any dependency or requirement relating to any one or to any combination of components as illustrated in FIG. 7.

Additionally, implementations for mobile internet services discovery and/or provisioning may be realized with numerous other general purpose or special purpose device (including computing system) environments or configurations. Examples of well known devices, systems, environments, and/or configurations that may be suitable for use include, but are not limited to, personal computers, server computers, thin clients, thick clients, personal digital assistants (PDAs) or mobile telephones, watches, hand-held or laptop devices, multiprocessor systems, microprocessor-based systems, set-top boxes, programmable consumer electronics, video game machines, game consoles, portable or handheld gaming units, network PCs, videoconferencing equipment, minicomputers, mainframe computers, network nodes, distributed or multi-processing computing environments that include any of the above systems or devices, some combination thereof, and so forth.

Implementations for mobile internet services discovery and/or provisioning may be described in the general context of processor-executable instructions. Generally, processor-executable instructions include routines, programs, protocols, objects, functions, interfaces, components, data structures, etc. that perform and/or enable particular tasks and/or implement particular abstract data types. Realizations of mobile internet services discovery and/or provisioning, as described in certain implementations herein, may also be practiced in distributed processing environments where tasks are performed by remotely-linked processing devices that are connected through a communications link and/or network. Especially but not exclusively in a distributed computing environment, processor-executable instructions may be located in separate storage media, executed by different processors, and/or propagated over transmission media.

Example operating environment 700 includes a general-purpose computing device in the form of a computer 702, which may comprise any (e.g., electronic) device with computing/processing capabilities. The components of computer 702 may include, but are not limited to, one or more processors or processing units 704, a system memory 706, and a system bus 708 that couples various system components including processor 704 to system memory 706.

Processors 704 are not limited by the materials from which they are formed or the processing mechanisms employed therein. For example, processors 704 may be comprised of semiconductor(s) and/or transistors (e.g., electronic integrated circuits (ICs)). In such a context, processor-executable instructions may be electronically-executable instructions. Alternatively, the mechanisms of or for processors 704, and thus of or for computer 702, may include, but are not limited to, quantum computing, optical computing, mechanical computing (e.g., using nanotechnology), and so forth.

System bus 708 represents one or more of any of many types of wired or wireless bus structures, including a memory bus or memory controller, a point-to-point connection, a switching fabric, a peripheral bus, an accelerated graphics port, and a processor or local bus using any of a variety of bus architectures. By way of example, such architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, some combination thereof, and so forth.

Computer 702 typically includes a variety of processor-accessible media. Such media may be any available media that is accessible by computer 702 or another (e.g., electronic) device, and it includes both volatile and non-volatile media, removable and non-removable media, and storage and transmission media.

System memory 706 includes processor-accessible storage media in the form of volatile memory, such as random access memory (RAM) 710, and/or non-volatile memory, such as read only memory (ROM) 712. A basic input/output system (BIOS) 714, containing the basic routines that help to transfer information between elements within computer 702, such as during start-up, is typically stored in ROM 712. RAM 710 typically contains data and/or program modules/instructions that are immediately accessible to and/or being presently operated on by processing unit 704.

Computer 702 may also include other removable/non-removable and/or volatile/non-volatile storage media. By way of example, FIG. 7 illustrates a hard disk drive or disk drive array 716 for reading from and writing to a (typically) non-removable, non-volatile magnetic media (not separately shown); a magnetic disk drive 718 for reading from and writing to a (typically) removable, non-volatile magnetic disk 720 (e.g., a “floppy disk”); and an optical disk drive 722 for reading from and/or writing to a (typically) removable, non-volatile optical disk 724 such as a CD, DVD, or other optical media. Hard disk drive 716, magnetic disk drive 718, and optical disk drive 722 are each connected to system bus 708 by one or more storage media interfaces 726. Alternatively, hard disk drive 716, magnetic disk drive 718, and optical disk drive 722 may be connected to system bus 708 by one or more other separate or combined interfaces (not shown).

The disk drives and their associated processor-accessible media provide non-volatile storage of processor-executable instructions, such as data structures, program modules, and other data for computer 702. Although example computer 702 illustrates a hard disk 716, a removable magnetic disk 720, and a removable optical disk 724, it is to be appreciated that other types of processor-accessible media may store instructions that are accessible by a device, such as magnetic cassettes or other magnetic storage devices, flash memory, compact disks (CDs), digital versatile disks (DVDs) or other optical storage, RAM, ROM, electrically-erasable programmable read-only memories (EEPROM), and so forth. Such media may also include so-called special purpose or hard-wired IC chips. In other words, any processor-accessible media may be utilized to realize the storage media of the example operating environment 700.

Any number of program modules (or other units or sets of processor-executable instructions) may be stored on hard disk 716, magnetic disk 720, optical disk 724, ROM 712, and/or RAM 710, including by way of general example, an operating system 728, one or more application programs 730, other program modules 732, and program data 734. These processor-executable instructions may include, for example, one or more of: mobile internet services shell 202 and the components thereof, mobile internet services proxy 304, internet service directory 306 and the information portions thereof, communication protocols 402/404/406/408/410, provisioning information, some combination thereof, and so forth.

A user may enter commands and/or information into computer 702 via input devices such as a keyboard 736 and a pointing device 738 (e.g., a “mouse”). Other input devices 740 (not shown specifically) may include a microphone, joystick, game pad, satellite dish, serial port, video camera, scanner, and/or the like. These and other input devices are connected to processing unit 704 via input/output interfaces 742 that are coupled to system bus 708. However, input devices and/or output devices may instead be connected by other interface and bus structures, such as a parallel port, a game port, a universal serial bus (USB) port, an infrared port, an IEEE 1394 (“Firewire”) interface, an IEEE 802.11 wireless interface, a Bluetooth® wireless interface, and so forth.

A monitor/view screen 744 or other type of display device may also be connected to system bus 708 via an interface, such as a video adapter 746. Video adapter 746 (or another component) may be or may include a graphics card for processing graphics-intensive calculations and for handling demanding display requirements. Typically, a graphics card includes a graphics processing unit (GPU), video RAM (VRAM), etc. to facilitate the expeditious display of graphics and performance of graphics operations. In addition to monitor 744, other output peripheral devices may include components such as speakers (not shown) and a printer 748, which may be connected to computer 702 via input/output interfaces 742.

Computer 702 may operate in a networked environment using logical connections to one or more remote computers, such as a remote computing device 750. By way of example, remote computing device 750 may be a peripheral device, a personal computer, a portable computer (e.g., laptop computer, tablet computer, PDA, mobile station, etc.), a palm or pocket-sized computer, a watch, a gaming device, a server, a router, a network computer, a peer device, another network node, or another device type as listed above, and so forth. However, remote computing device 750 is illustrated as a portable computer that may include many or all of the elements and features described herein with respect to computer 702.

Logical connections between computer 702 and remote computer 750 are depicted as a local area network (LAN) 752 and a general wide area network (WAN) 754. Such networking environments are commonplace in offices, enterprise-wide computer networks, intranets, the Internet, fixed and mobile telephone networks, ad-hoc and infrastructure wireless networks, mesh networks, other wireless networks, gaming networks, some combination thereof, and so forth. Such networks and logical and physical communications connections are additional examples of transmission media.

When implemented in a LAN networking environment, computer 702 is usually connected to LAN 752 via a network interface or adapter 756. When implemented in a WAN networking environment, computer 702 typically includes a modem 758 or other component for establishing communications over WAN 754. Modem 758, which may be internal or external to computer 702, may be connected to system bus 708 via input/output interfaces 742 or any other appropriate mechanism(s). It is to be appreciated that the illustrated network connections are examples and that other manners for establishing communication link(s) between computers 702 and 750 may be employed.

In a networked environment, such as that illustrated with operating environment 700, program modules or other instructions that are depicted relative to computer 702, or portions thereof, may be fully or partially stored in a remote media storage device. By way of example, remote application programs 760 reside on a memory component of remote computer 750 but may be usable or otherwise accessible via computer 702. Also, for purposes of illustration, application programs 730 and other processor-executable instructions such as operating systems 728 are illustrated herein as discrete blocks, but it is recognized that such programs, components, and other instructions reside at various times in different storage components of computing device 702 (and/or remote computing device 750) and are executed by processor(s) 704 of computer 702 (and/or those of remote computing device 750).

Although systems, media, devices, methods, procedures, apparatuses, techniques, schemes, approaches, procedures, arrangements, and other implementations have been described in language specific to structural, logical, algorithmic, and functional features and/or diagrams, it is to be understood that the invention defined in the appended claims is not necessarily limited to the specific features or diagrams described. Rather, the specific features and diagrams are disclosed as exemplary forms of implementing the claimed invention.

What is claimed is:

1. A mobile device comprising:
a mobile internet services shell that is capable of discovering a mobile internet services proxy that is located on a network; the mobile internet services shell adapted to receive from the mobile internet services proxy a list of internet services that are available to a user of the mobile device, the mobile internet services shell further adapted to advertise the list of internet services to the user and to enable the user to select one or more internet services from the list of internet services.

2. The mobile device as recited in claim 1, wherein the mobile device is adapted to activate the mobile internet services shell in accordance with one or more of the following: when the user first powers on the mobile device, whenever the mobile device is powered on, and at predetermined intervals.

3. The mobile device as recited in claim 1, wherein the mobile internet services shell is further adapted to provision the one or more selected internet services with respect to a mobile network carrier to which the user is a subscriber.

4. The mobile device as recited in claim 3, wherein the mobile internet services shell is further adapted to download from an application server at least one mobile application that is associated with the one or more selected internet services.

5. The mobile device as recited in claim 4, wherein the mobile internet services shell is further adapted to provision the at least one downloaded application with respect to the user and/or the mobile device.

6. The mobile device as recited in claim 5, wherein the mobile internet services shell utilizes the mobile internet services proxy as an intermediary during at least one of: the carrier-level provisioning, the mobile application downloading, or the user-level provisioning.

7. The mobile device as recited in claim 1, wherein the mobile internet services shell is further adapted to send discovery information to the mobile internet services proxy upon discovering the mobile internet services proxy; and wherein the discovery information comprises at least one of: (i) an identifier of the user, (ii) an original equipment manufacturer (OEM) device model and/or serial number of the mobile device, (iii) a mobile network operator corresponding to the user, or (iv) an operating system (OS) of the mobile device.

8. One or more processor-accessible media including processor-executable instructions that comprise a mobile internet services proxy, wherein execution of the processor-executable instruction causes a device to perform actions comprising:
establishing a session context with a mobile internet services shell, the session context establishment including an identification of a subscriber;
interrogating an internet service directory on behalf of the mobile internet services shell with reference to the identification of the subscriber; and
providing a list of internet services to the mobile internet services shell, the list including those internet services that are available to the subscriber.

9. The one or more processor-accessible media as recited in claim 8, wherein the identification of the subscriber comprises at least one of: a subscriber number assigned by a mobile network operator corresponding to the subscriber, a telephone number, a number from a subscriber identification/identity module (SIM), or an electronic serial number (ESN) of a mobile device on which the mobile internet services shell is executing.

10. The one or more processor-accessible media as recited in claim 8, wherein the actions of establishing and providing are effectuated using a proxy-shell protocol, and the action of interrogating is effectuated using a proprietary carrier protocol.

11. The one or more processor-accessible media as recited in claim 8, comprising the processor-executable instructions that, when executed, direct the device to perform further actions comprising:
receiving from the mobile internet services shell a request to initiate carrier-level provisioning with respect to a selected internet service from the list of internet services;
translating the request from a proxy-shell format into a carrier-appropriate format;
requesting from a provisioning server carrier-related provisioning information with respect to the selected internet service; and
forwarding to the mobile internet services shell the carrier-related provisioning information in the proxy-shell format.

12. The one or more processor-accessible media as recited in claim 11, wherein the carrier-related provisioning information comprises one or more of network settings, protocol settings, device settings, and application-specific settings.

13. The one or more processor-accessible media as recited in claim 8, comprising the processor-executable instructions that, when executed, direct the device to perform further actions comprising:
facilitating a downloading of a mobile application, which is associated with an internet service selected from the list of internet services, from an application server to a mobile device on which the mobile internet services shell is executing.

14. The one or more processor-accessible media as recited in claim 8, comprising the processor-executable instructions that, when executed, direct the device to perform further actions comprising:
receiving from the mobile internet services shell a request to initiate user-level provisioning with respect to a mobile application that is associated with a selected internet service from the list of internet services;
translating the request from a proxy-shell format into a carrier-appropriate format;
requesting from a provisioning server user-related provisioning information with respect to the mobile application that is associated with the selected internet service; and
forwarding to the mobile internet services shell the user-related provisioning information in the proxy-shell format.

15. The one or more processor-accessible media as recited in claim 14, wherein the user-related provisioning information comprises one or more of authentication information, application-specific information, and application-specific settings.

16. A method comprising:
discovering, by a mobile internet services shell, a mobile internet services proxy;
requesting, by the mobile internet services proxy, a list of internet services that are available to a user, the requesting effectuated using a carrier-appropriate protocol;
receiving the list of available internet services at the mobile internet services proxy; and
sending the list of available internet services from the mobile internet services proxy to the mobile internet services shell using a proxy-shell protocol.

17. The method as recited in claim 16, further comprising:
advertising, by the mobile internet services shell, the list of available internet services to the user at a mobile device; and
empowering the user to select one or more internet services from the list of available internet services.

18. The method as recited in claim 17, wherein the mobile internet services shell is located at the mobile device, and the mobile internet services proxy is located at fixed node of a network.

19. The method as recited in claim 17, further comprising:
initiating, by the mobile internet services shell, provisioning for the selected one or more internet services;
requesting, by the mobile internet services proxy, provisioning information for the selected one or more internet services, the requesting effectuated using the carrier-appropriate protocol;
receiving the provisioning information at the mobile internet services proxy; and
sending the provisioning information from the mobile internet services proxy to the mobile internet services shell using the proxy-shell protocol.

20. The method as recited in claim 17, further comprising:
downloading at least one mobile application that is associated with the selected one or more internet services to the mobile device using the mobile internet services shell at the mobile device and the mobile internet services proxy as an intermediary.
